(19) United States
(12) Patent Application Publication
(10) Pub. No.: US 2025/0357769 A1
(43) Pub. Date: Nov. 20, 2025

(54) SYSTEM FOR BALANCING A BATTERY GROUP AND BALANCE CONTROL CIRCUIT AND METHOD THEREOF

(71) Applicant: Chengdu Monolithic Power Systems Co., Ltd., Chengdu (CN)

(72) Inventor: Lei Du, Hangzhou (CN)

(21) Appl. No.: 19/209,178

(22) Filed: May 15, 2025

(30) Foreign Application Priority Data
May 16, 2024 (CN) 202410612978.7

(51) Int. Cl. H02J 7/00

(52) U.S. Cl. CPC H02J 7/0018; H02J 7/00032; H02J 7/0048

(57) ABSTRACT

A balance control circuit and other balance control circuits are coupled in a daisy chain configuration for balancing a battery group with a plurality of battery cells. The plurality of battery cells are grouped into multiple sub-groups in which a nth cell (n≥3) is shared by two adjacent sub-groups. The balance control circuit has a first cell pin coupled to a cathode of a first battery cell, a second cell pin to a (n+1)th cell pin coupled by ordinal to an anode of the first battery cell to an anode of the nth battery cell, a digital input terminal for receiving a balance control signal with digital coded pulse train, and a high-side transmission terminal operable for transmitting the balance control signal to a digital input terminal of a latter balance control circuit in the daisy chain.

### CROSS-REFERENCE TO RELATED APPLICATIONS

This application claims the benefit of CN application No. 202410612978.7, filed on May 16, 2024, and incorporated herein by reference.

### TECHNICAL FIELD

The present invention generally relates to electronic circuits, and more particularly but not exclusively, to systems for balancing a battery group and associated balance control circuits and methods.

### BACKGROUND

A battery module is often composed of a certain number of cells. By connecting the cells in series, the voltages of multiple cells are accumulated, thereby achieving a high output voltage. There are distinctions among the cells in many parameters including charging status, impedance and/or temperature characteristics, the mis-matched cells would result in reduction of total capacity and life span of the battery module. Thus, it is necessary to use balance control to balance the cells, to ensure battery module capacity and stable performance.

Furthermore, a battery pack is usually assembled from several battery modules. It is widely used in electric vehicles, hybrid vehicles, energy storage systems, and other applications requiring large capacity and higher-level voltage. Communication among the several battery modules for data interaction is also needed for battery status estimation and balance control for the whole batter back.

### SUMMARY

There has been provided, in accordance with an embodiment of the present disclosure, a balance control circuit. The balance control circuit comprises a first cell pin configured to be coupled to a cathode of a first battery cell of a battery group with n battery cells connected by ordinal in a series structure, a second cell pin to a (n+1)th cell pin coupled by ordinal to an anode of the first battery cell to an anode of a nth battery cell of the battery group, a digital input terminal configured to receive a balance control signal with digital coded pulse train, and a high-side transmission terminal operable to be coupled to a second digital input terminal of a latter balance control circuit in a daisy chain to transmit the balance control signal.

There also has been provided, in accordance with an embodiment of the present disclosure, a system for balancing a battery group with a plurality of battery cells. The plurality of battery cells are grouped into m sub-groups in which a nth cell (n≥3) is shared by two adjacent sub-groups. The system comprises m balance control circuits configured in a daisy chain and respectively configured for balancing a corresponding sub-group of the m sub-groups. Each balance control circuit comprises a first cell pin configured to be coupled to a cathode of a first battery cell of the corresponding sub-group, a second cell pin to a (n+1)th cell pin coupled by ordinal to an anode of the first battery cell to an anode of the nth battery cell of the corresponding sub-group, a digital input terminal configured to receive a balance control signal with digital coded pulse train, and a high-side transmission terminal operable to be coupled to a digital input terminal of a latter balance control circuit in a daisy chain to transmit the balance control signal.

There also has been provided, in accordance with an embodiment of the present disclosure, a method for balancing a battery group performed by a balance control circuit. The balance control circuit and other balance control circuits are coupled in a daisy chain configuration. The battery group has a plurality of battery cells grouped into multiple sub-groups in which a nth battery cell (n≥3) is shared by two adjacent sub-groups. The method comprises the following steps. A first cell pin of the balance control circuit is coupled to a cathode of a first battery cell of the corresponding sub-group. A second cell pin to a (n+1)th cell pin of the balance control circuit are coupled by ordinal to the anode of the first battery cell to the anode of the nth battery cell of the corresponding sub-group. A balance control signal with digital coded pulse train is received at a digital input terminal of the balance control circuit. The balance control signal is transmitted from a high-side transmission terminal of the balance control circuit to a digital input terminal of a latter balance control circuit in the daisy chain.

### BRIEF DESCRIPTION OF DRAWINGS

The present invention can be further understood with reference to the following detailed description and the appended drawings, wherein like elements are provided with like reference numerals.

FIG. 1 illustrates a schematic block diagram of a system 100 for balancing a battery group in accordance with an embodiment of the present disclosure.

FIG. 2 illustrates a sequence diagram of a balance control signal BCTRL in accordance with an embodiment of the present disclosure.

FIG. 3 illustrates a data write transaction structure of the balance control signal BCTRL in accordance with an embodiment of the present disclosure.

FIG. 4 illustrates a schematic diagram of a system 100A for balancing a battery group in accordance with an embodiment of the present disclosure.

FIG. 5 illustrates a schematic diagram of a system 100B for balancing a battery group in accordance with an embodiment of the present disclosure.

FIG. 6 illustrates a balance control circuit IC in a system for balancing a battery group in accordance with an embodiment of the present disclosure.

FIG. 7 illustrates a flow diagram of a method 700 for balancing a battery group in accordance with an embodiment of the present disclosure.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration, and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

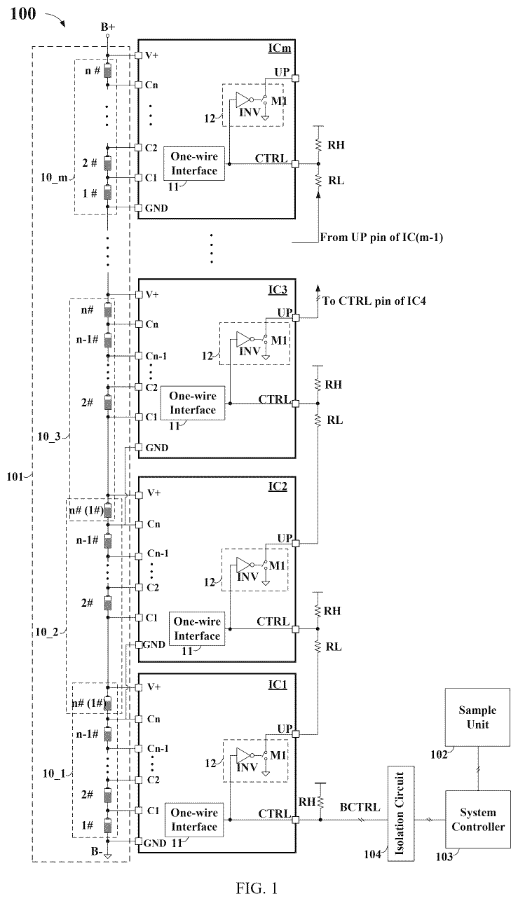

FIG. 1 illustrates a schematic block diagram of a system 100 for balancing a battery group in accordance with an embodiment of the present disclosure. As shown in FIG. 1, the system 100 comprises a battery group 101, a sample unit 102, a system controller 103, and m balance control circuits IC1˜ICm configured in a daisy chain. The battery group 101 includes a plurality of battery cells connected by ordinal in a series structure. The plurality of battery cells are coupled between a positive battery group terminal B+ and a negative battery group terminal B−.

In an example shown in FIG. 1, the plurality of battery cells of the battery group 101 are grouped into multiple sub-groups 10_1˜10_m. Each sub-group comprises a first battery cell, a second battery cell, . . . , a nth battery cell, which are connected by ordinal in the series structure. Wherein n is an integer higher than 3 or equal to 3. The nth cell is shared by two adjacent sub-groups. For example, the nth cell of the sub-group 10_1 is shared as the first battery cell of the sub-group 10_2, and the nth cell of the sub-group 10_2 is shared as the first battery cell of the sub-group 10_3.

Each battery cell is the smallest unit and has an anode and a cathode. The sample unit 102 is coupled to every battery cell and is configured to sense battery cell voltage of each battery cell. The system controller 103 and the sample unit 102 are coupled together and are configured to receive and monitor the battery cell voltage of every battery cell, to perform battery status estimation of each battery cell. The system controller 103 is further configured to provide a balance control signal BCTRL for managing the battery cell's charge and discharge process, to meet the balance requirements between the two adjacent sub-groups and the balance requirements inside each of the m sub-groups 10_1˜10_m.

Each of the m balance control circuits IC1˜ICm may be configured as an integrated circuit. The m balance control circuits IC1˜ICm are stacked assembly from the balance control circuit IC1 to the balance control circuit ICm and are coupled by ordinal to form the daisy chain configuration. A respective balance control circuit is corresponding to a sub-group of the m sub-groups 10_1˜10_m, and finally, the battery group 101 is balanced by the m balance control circuits IC1˜ICm. In one embodiment, the balance control circuit is configured to transfer the energy among the n battery cells of the corresponding sub-group, for example, to control the energy to be transferred from the battery cell with the highest voltage in the corresponding sub-group to other batter cells in the corresponding sub-group. In another embodiment, the balance control circuit is configured to transfer energy to the battery cell with the lowest voltage in the corresponding sub-group from other batter cells in the corresponding sub-group. In yet another embodiment, the balance control circuit is configured to discharge the sub-group with a higher sub-group voltage and to charge the one with a lower sub-group voltage, until the balance among the m sub-groups is reached.

Each balance control circuit comprises a plurality of terminals. As shown in FIG. 1, the balance control circuit IC1 has the plurality of terminals including a first cell pin GND, a second cell pin C1 to a (n+1)th cell pin V+, a digital input terminal CTRL and a high-side transmission terminal UP. The first cell pin GND is coupled to the cathode of the first battery cell of the corresponding sub-group 10_1. The second cell pin C1 to the nth cell pin Cn are coupled by ordinal to the anode of the first battery cell to the anode of the (n−1)th battery cell of the sub-group 10_1, the (n+1)th cell pin V+ is coupled to the anode of the nth battery cell.

Referring still to FIG. 1, the balance control circuit IC1 is located at the bottom of the daisy chain. The first cell pin GND of the balance control circuit IC1 is coupled to the negative battery group terminal B−. The digital input terminal CTRL of the balance control circuit IC1 is coupled to the system controller 103 through an isolation circuit 104, to receive the balance control signal BCTRL provided by the system controller 103. The high-side transmission terminal UP of the balance control circuit IC1 is operable to be coupled to the digital input terminal CTRL of a latter balance control circuit (IC2) in the daisy chain for transmitting the balance control signal BCTRL. In one embodiment, the isolation circuit 104 may comprise opto-coupler, transformer, capacitor or any other suitable electrical isolation device.

Referring still to FIG. 1, the first cell pin GND of the balance control circuit IC2 is coupled to the cathode of the first battery cell of the sub-group 10_2. The first battery cell of the sub-group 10_2 is also shared as the nth battery cell of the sub-group 10_1. The second cell pin C1 to the nth cell pin Cn−1 of the balance control circuit IC2 are coupled by ordinal to the anode of the first battery cell to the anode of the (n−1)th battery cell of the corresponding sub-group 10_2, the (n+1)th cell pin V+ of the balance control circuit IC2 is coupled to the anode of the nth battery cell of the corresponding sub-group 10_2. The digital input terminal CTRL of the balance control circuit IC2 is coupled to the high-side transmission terminal UP of the previous balance control circuit IC1 in the daisy chain, to receive the balance control signal BCTRL transmitted by the balance control circuit IC1. The high-side transmission terminal UP of the balance control circuit IC2 is configured to transmit the balance control signal BCTRL to the digital input terminal CTRL of the latter balance control circuit (IC3) in the daisy chain.

As shown in FIG. 1, the balance control circuit ICm is located at the top of the daisy chain. The (n+1)th cell pin V+ of the balance control circuit ICm is coupled to the positive battery group terminal B+.

In one embodiment, the number of the battery cells for the different sub-groups could be different. In an example, the sub-group 10_m corresponding to the balance control circuit ICm located at the top of the daisy chain may comprise d battery cells. Wherein d is an integer higher than 3 and equal to 3, and less than n. The battery cell located at the ends of the sub-group is shared by the two adjacent sub-groups. In a further embodiment, the sub-group 10_m has 3 battery cells. The fourth cell pin C3 to the (n+1)th cell pin V+ are all coupled to the anode of the third battery cell of the sub-group 10_m.

When any balance requirement comes, the system controller 103 provides the balance control signal BCTRL with digital coded pulse train to the digital input terminal CTRL of the balance control circuit IC1 located at the bottom of the daisy chain. Subsequently, the received balance control signal BCTRL is transmitted through the high-side transmission terminal UP to the latter balance control circuit IC2 and is successively transmitted to the balance control circuits IC3˜ICm one by one. The digital input terminals CTRL of the balance control circuits all receive and share the balance control signal BCTRL. Each balance control circuit is configured to transmit the balance control signal BCTRL to the digital input terminal CTRL of the latter balance control circuit in the daisy chain through the high-side transmission terminal UP.

Referring still to FIG. 1, each balance control circuit further comprises a one-wire interface circuit 11 and a pulse transmitter 12. In an embodiment, the one-wire interface circuit 11 is coupled to the digital input terminal CTRL, to receive the balance control signal BCTRL with digital coded pulse train. The balance control circuit is controlled based on the pulse number of the digital coded pulse train. The pulse transmitter 12 is configured to transmit the balance control signal BCTRL received at the digital input terminal CTRL to the high-side transmission terminal UP. In an example, the high-side transmission terminal UP of the balance control circuit IC1 transmits the balance control signal BCTRL to the digital input terminal CTRL of the latter balance control circuit IC2 in the daisy chain.

In an embodiment, the pulse transmitter 12 comprises an inverter INV and a switch M1 as shown in FIG. 1. An input terminal of the inverter INV is coupled to the digital input terminal CTRL to receive the balance control signal BCTRL. An output terminal of the inverter INV is coupled to a control terminal of the switch M1. The switch M1 has a first terminal coupled to the high-side transmission terminal UP and a second terminal coupled to ground. As shown in FIG. 1, the pulse transmitter 12 transmits the balance control signal BCTRL received at the digital input terminal CTRL to the high-side transmission terminal UP. Subsequently, the balance control signal BCTRL is transmitted and is shared to the digital input terminal CTRL of the latter balance control circuit in the daisy chain.

In accordance with an exemplary embodiment of the present invention, under the control of the balance control signal BCTRL, the battery cell with the higher voltage is discharged and the batter cell with the lower voltage is charged, until the balance of the multiple battery cells is reached. In accordance with another exemplary embodiment of the present invention, under the control of the balance control signal BCTRL, the sub-group with the higher sub-group voltage is discharged and the one with the lower sub-group voltage is charged, until the balance among the multiple sub-groups is reached.

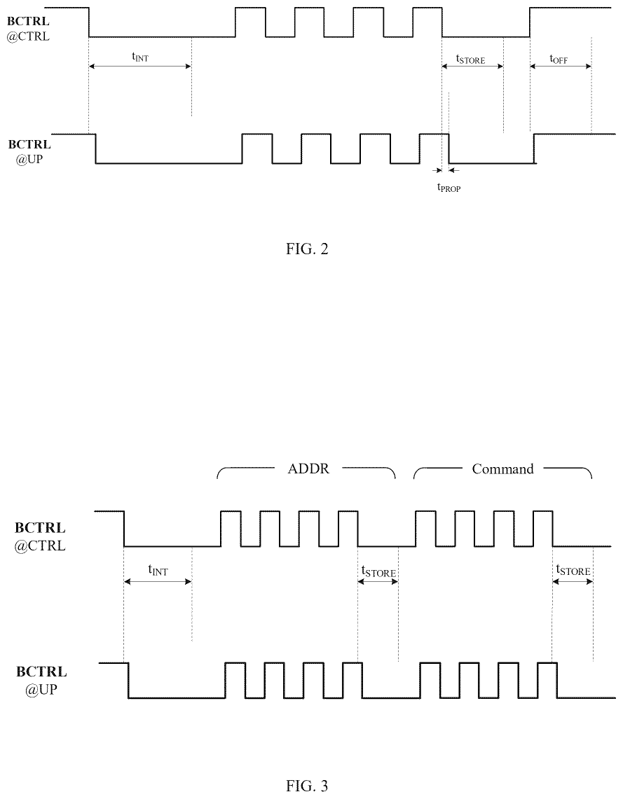

FIG. 2 illustrates a sequence diagram of a balance control signal BCTRL in accordance with an embodiment of the present disclosure. As shown in FIG. 2, when no communication is in progress, the digital input terminal CTRL and the high-side transmission terminal UP are in an idle state, the balance control signal BCTRL is pulled up to a high level by an external pull-up resistor RH as shown in FIG. 1.

At the beginning of communication, the balance control circuits IC1˜ICm are all in idle state, the system controller 103 sends a low level having a width of being not lower than 50 us and not higher than 500 ms to indicate a start condition (e.g., tINT as shown in FIG. 2), indicating the start of the communication. The balance control circuits IC1˜ICm are ready to receive the balance control signal BCTRL at the digital input terminals CTRL after receiving the start condition. Then the system controller 103 sends the balance control signal BCTRL with the digital coded pulse train having a plurality of pulses, and the balance control circuit IC1˜ICm receives the balance control signal BCTRL at the digital input terminals CTRL and issues at the high-side transmission terminals UP. The plurality of pulses of the balance control signal BCTRL are sequentially transmitted pulse by pulse, in accordance with a sequence of a data transmission structure shown in FIG. 3.

The balance control circuits IC1˜ICm receives the digital coded pulse train of the balance control signal BCTRL and saves them in the one-wire interface circuit 11 shown in FIG. 1 within a preset storage period tSTORE. When the transmission of the digital coded pulse train is completed, the system controller 103 will send an end condition. After receiving the end condition, the digital input terminals CTRL of the balance control circuits IC1˜ICm is pulled up to the high level by the external pull-up resistor RH as shown in FIG. 1. When the high level width reaches a tuning-off period toFF, and the digital input terminal CTRL and the high-side transmission terminal UP return to the idle state. As shown in FIG. 2, the digital coded pulse train transmitted at the digital input terminal CTRL and the one transmitted at the high-side transmission terminal UP are substantially the same, there is only a little time delay T_{PROP}.

FIG. 3 illustrates a data write transaction structure of the balance control signal BCTRL in accordance with an embodiment of the present disclosure. As shown in FIG. 3, the balance control signal BCTRL changes between the high level and low level to form the digital coded pulse train for providing the control data and/or time data of the balance control circuits IC1˜ICm.

In the example shown in FIG. 3, the data write transaction structure of the digital coded pulse train at least comprises an address coded pulse burst ADDR, a Read/Write indicating pulse burst, and a command coded pulse burst. The Read/Write indicating pulse burst and the command coded pulse burst are used for transmitting command data. Each balance control circuit in the daisy chain has a unique address for communication with the system controller 103. Each balance control circuit is configured to identify whether its own address is matched with the address indicated by the address coded pulse burst ADDR. The Read/Write indicating pulse burst indicates that the balance control circuit is in Read mode or Write mode. The command coded pulse burst is used to control the address-matched balance control circuit to operate for meeting the balance requirements.

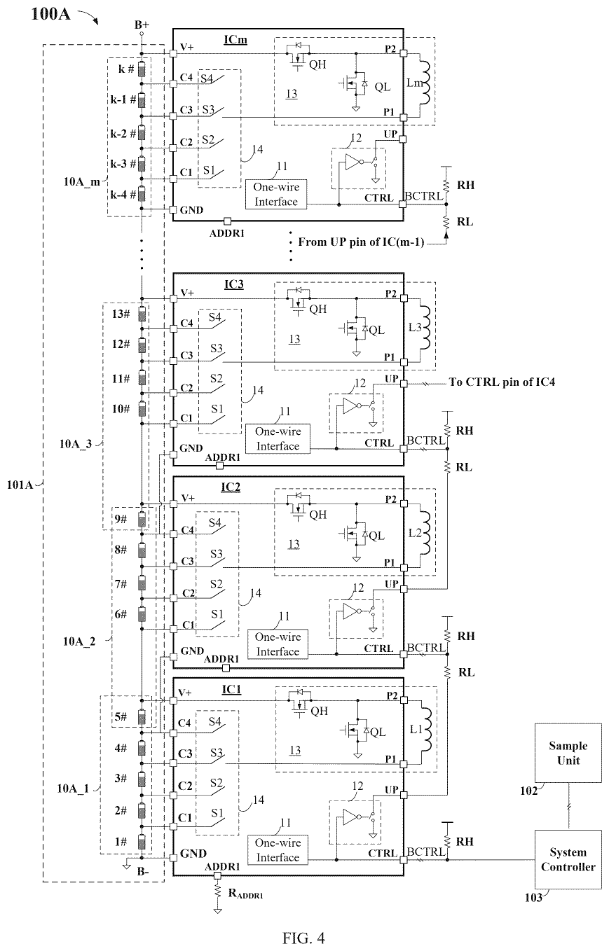

FIG. 4 illustrates a schematic diagram of a system 100A for balancing a battery group in accordance with an embodiment of the present disclosure. As shown in FIG. 4, the system 100A comprises a battery group 101A, a sample unit 102, a system controller 103 and m balance control circuits IC1˜ICm configured as a daisy chain.

The battery group 101A comprises k battery cells coupled between the positive battery group terminal B+ and the negative battery group terminal B−. The k battery cells are grouped into m sub-groups 10A_1˜10A_m. The battery cell located at the ends of the sub-group may be shared by the two adjacent sub-groups. In the example shown in FIG. 4, the sub-group 10A_1 has 5 battery cells connected by ordinal in the series structure, i.e., the first battery cell to the fifth battery cell. The sub-group 10A_2 has the fifth battery cell to the ninth battery cell connected in series. The sub-group 10A_3 has the ninth battery cell to the thirteen battery cell connected in series. And the sub-group 10A_m has 5 battery cells connected by ordinal in the series structure, i.e., the (k−4)th battery cell to the kth battery cell. As shown in FIG. 4, the sub-group 10A_1 and the sub-group 10A_2 share the fifth battery cell, the sub-group 10A_2 and the sub-group 10A_3 share the ninth battery cell. In other words, one of the battery cells at the two ends of the sub-group 10A_2 is shared by the adjacent sub-groups.

In the example shown in FIG. 4, the sample unit 102 is configured to collect the voltage information of each battery cell in the battery group 101A. The system controller 103 is coupled to the sample unit 102 and is configured to receive and monitor the battery cell voltage of every battery cell, to perform battery status estimation of each battery cell. The system controller 103 is further configured to provide the balance control signal BCTRL to meet the balance requirements of the battery group 101A.

Each of the m balance control circuits IC1˜ICm may be configured as an integrated circuit. The m balance control circuits IC1˜ICm are stacked and assembled to form the daisy chain configuration as shown in FIG. 4. A respective balance control circuit is corresponding to one of the m sub-groups 10A_1˜10A_m. Each balance control circuit comprises a one-wire interface circuit 11, a pulse transmitter 12, a plurality of conduction paths 14, a pair of switches that is made up of a high-side switch QH and a low-side switch QL connected in series, and a plurality of terminals.

In an exemplary embodiment, the plurality of terminals of the balance control circuit IC1 includes a first cell pin GND, a second cell pin C1 to a fifth cell pin C4, a sixth cell pin V+, a digital input terminal CTRL, a high-side transmission terminal UP, an address configuration terminal ADDR1, a first power terminal P1 and a second power terminal P2. As shown in FIG. 4, the first cell pin GND is coupled to the cathode of the first battery cell of the sub-group 10A_1. The second cell pin C1 to the fifth cell pin C4 are coupled by ordinal to the anode of the first battery cell and the anode of the fourth battery cell in the sub-group 10A_1, the sixth cell pin V+ is coupled to the anode of the fifth battery cell.

The address configuration terminal ADDR1 is configured to set the unique address by connecting an external resistor R_{ADDR1}, for address identification when communicating with the system controller 103. One of ordinary skill in the art should understand that this is just to provide an example, the address configuration terminal ADDR1 may be optional or unnecessary for address configuration, the balance control circuits IC1˜ICm may use other ways to configure the address for communication.

Referring still to FIG. 4, the first power terminal P1 is coupled to the second power terminal P2 through an inductor L1. The pair of switches (including a high-side switch QH and a low-side switch QL) is coupled between the sixth cell pin V+ and the first cell pin GND, and the switch node of the pair of switches is coupled to the second power terminal P2. As shown in FIG. 4, the pair of switches and the inductor L1 are coupled to form an energy transfer unit 13.

In accordance with an exemplary embodiment of the present invention, for the sub-group with n battery cells connected by ordinal in series structure, the plurality of conduction paths 14 comprise n−1 switchable conductive paths S1˜S (n−1). As shown in FIG. 4, the plurality of conduction paths 14 comprise 4 switchable conductive paths S1˜S4, and each conduction path has a pair of bi-directional MOSFETs connected in series. In the example shown in FIG. 4, one of the 4 conduction paths 14 is selectively activated to provide electronic connection between the first power terminal P1 and one of from the second cell pin C1 to the fifth cell pin C4.

The system controller 103 is communicated with each balance control circuit in the daisy chain through the balance control signal BCTRL. The balance control signal BCTRL is firstly sent from the system controller 103 and is successively to each balance control circuit from the bottom to the top of the daisy chain. The digital input terminals CTRL of the balance control circuits IC1˜ICm receive and share the balance control signal BCTRL, and they are configured to decode the address data indicated by the address coded pulse burst ADDR. When the address matching is identified by the balance control circuit, the pair of switches is controlled to perform a buck or boost operation and one of the n−1 conduction paths 14 is selectively activated based on the command coded pulse burst of the balance control signal BCTRL, for meeting the balance requirements of the battery group 101A.

In detail, the one-wire interface circuit 11 is coupled to the digital input terminal CTRL to receive the balance control signal BCTRL and provides the control data based on the pulse number of the balance control signal BCTRL. The balance control circuit performs balance control based on the control data. In an embodiment, the address-matched balance control circuit turns on one of 4 switchable conductive paths S1˜S4 based on the control data or the command data.

In an embodiment, for the balance control circuit IC1 for balancing the sub-group 10A_1 with n battery cells. The switch node of the pair of switches is connected to a first terminal of the inductor L1, a second terminal of the inductor L1 is configured to be selectively coupled to an anode or a cathode of a target cell in the sub-group 10A_1. The energy transfer unit 13 is configured to operate in the buck mode or the boost mode for transferring energy among the n battery cells of the sub-group 10A_1.

In another embodiment, the balance between two sub-groups can be reached. For example, when the balance requirements between the two sub-groups 10A_1 and 10A_2 come, the system controller 103 provides the balance control signal BCTRL to communicate with the balance control circuits IC1 and IC2 through the identification of the address-matching. The balance control circuit IC1 turns on the switch S4 of the 4 conduction paths 14 and the balance control circuit IC2 turns on the switch S1, based on the balance control signal BCTRL. Furthermore, in response to the average voltage of the sub-group 10A_1 being higher than the average voltage of the sub-group 10A_2, the energy transfer units 13 of the balance control circuits IC1 and IC2 are both configured to work in the boost mode. In response to the average voltage of the sub-group 10A_1 being lower than the average voltage of the sub-group 10A_2, the energy transfer units 13 of the balance control circuits IC1 and IC2 are both configured to work in the buck mode.

In accordance with an exemplary embodiment of the present invention, the balance control circuits IC1˜ICm configured as the daisy chain can balance the battery group 101A with an active way, fast balancing with high current is performed among the battery cells in the battery group 101A. Compared with the passive balance control, the active balance control described above can reduce the balance time and thus improve the efficiency of balance. In this balance control, the reliability and capacity of the system 100A are improved, the life span of the system 100A is also ensured, and accordingly, energy conservation and emission reduction are achieved.

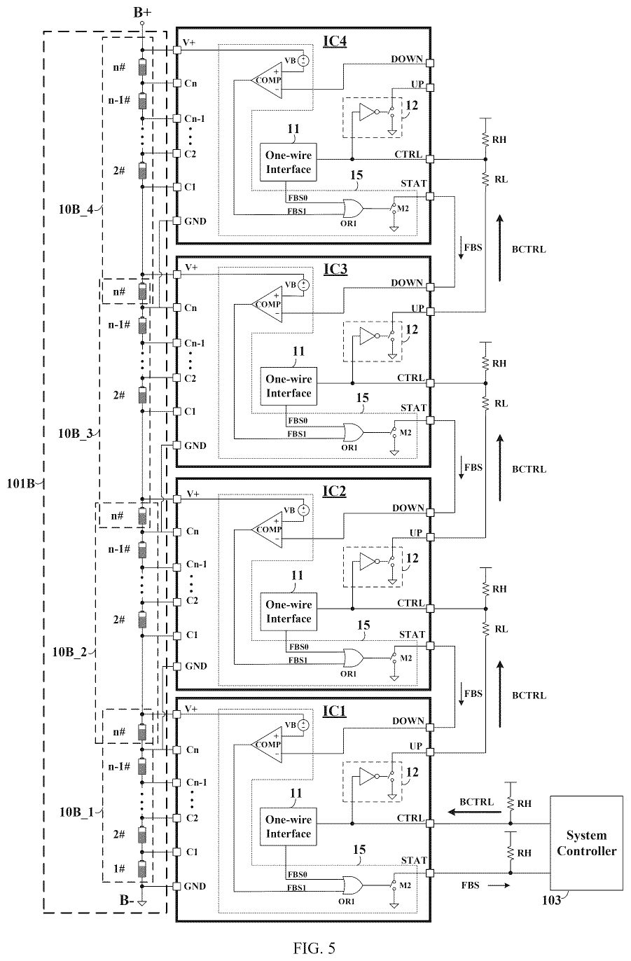

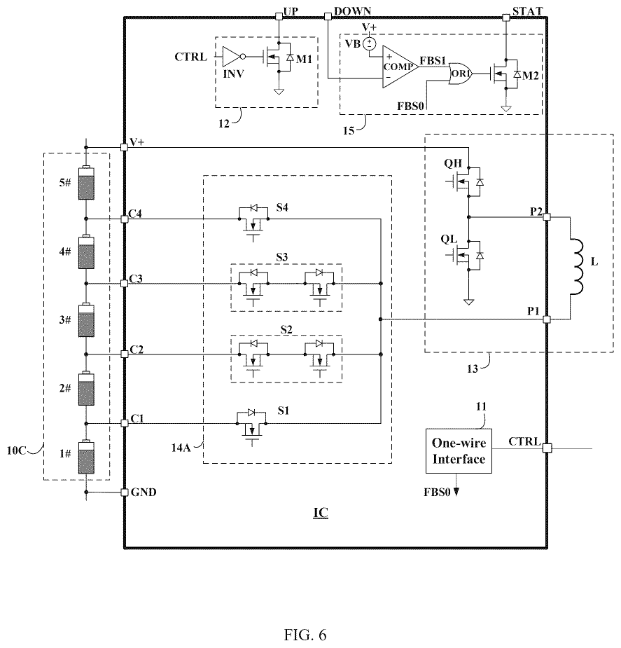

FIG. 5 illustrates a schematic diagram of a system 100B for balancing a battery group in accordance with an embodiment of the present disclosure. As shown in FIG. 5, the system 100B comprises a battery group 101B, a system controller 103, and the balance control circuits IC1˜IC4 configured as the daisy chain. The battery group 101B has a plurality of battery cells connected by ordinal in a series structure. The plurality of battery cells are coupled between a positive battery group terminal B+ and a negative battery group terminal B−. The plurality of battery cells are grouped into 4 sub-groups 10B_1˜10B_4, in which the battery cell located at the ends of the sub-group is shared by two adjacent sub-groups. In the example shown in FIG. 5, the nth cell (n≥3) is shared by two adjacent sub-groups.

In the example shown in FIG. 5, the system controller 103 communicates with the 4 balance control circuits IC1˜IC4 and provides the balance control signal BCTRL based on the battery cell voltage of each battery cell, and determines if to generate a fault signal based on a status feedback signal FBS provided by the balance control circuit. In an embodiment, the pulse number of the status feedback signal FBS indicates the status of the balance control circuit.

In the example shown in FIG. 5, each balance control circuit comprises a one-wire interface circuit 11, a pulse transmitter 12, a status transmitter 15 and a plurality of terminals including a first cell pin GND, cell pins C1˜Cn, a cell pin V+, a digital input terminal CTRL, a high-side transmission terminal UP, a status report terminal STAT and a low-side transmission terminal DOWN. In the example shown in FIG. 5, the energy transfer unit 13 and the plurality of conduction paths 14 are omitted for clarity.

In an example, the one-wire interface circuit 11 is coupled to the digital input terminal CTRL to receive the balance control signal BCTRL with digital coded pulse train. The one-wire interface circuit 11 provided and stores the control data based on the pulse number of the digital coded pulse train, for balance control. As shown in FIG. 5, the balance control signal BCTRL is transmitted to the balance control circuits from the bottom to the top of the daisy chain through the high-side transmission terminals UP and the digital input terminals CTRL.

As shown in FIG. 5, the transmission direction of the status feedback signal FBS and the transmission direction of the balance control signal BCTRL are opposite, i.e., from the top to the bottom of the daisy chain.

In an embodiment, for the balance control circuit IC2, when the Read/Write indicating pulse burst indicates that the balance control circuit IC2 is in Read mode, the one-wire interface circuit 11 of the balance control circuit IC2 provides a status feedback signal FBS0 to report the status of the current balance control circuit IC2. Furthermore, the low-side transmission terminal DOWN is coupled to the status report terminal STAT of the latter balance control circuit IC3 in the daisy chain, to receive the status feedback signal FBS. The received status feedback signal FBS is transmitted by the status transmitter 15 to the status report terminal STAT of the balance control circuit IC2 in the daisy chain. In this way, the status feedback signal FBS is transmitted from the top to the bottom of the daisy chain, and finally to the system controller 103. The system controller 103 is coupled to the status repot terminal STAT of the balance control circuit IC1 at the bottom of the daisy chain to receive the status data, which is highly flexible and monitorable.

In detail, the status transmitter 15 is configured to have a first transmission path and a second transmission path. The first transmission path is used for transmitting the status feedback signal FBS0 indicating the status of the current balance control circuit, to the status report terminal STAT. The low-side transmission terminal DOWN of the current balance control circuit receives a status feedback signal FBS1 indicating the status of the higher-side balance control circuit, and the second transmission path is used for transmitting the status feedback signal FBS1, to the status report terminal STAT of the current balance control circuit.

In the example shown in FIG. 5, the status transmitter 15 comprises a comparator COMP, a bias voltage source VB, an OR gate circuit OR1 and a switch M2. The bias voltage source VB has a power supply terminal and an output terminal, wherein the power supply terminal is coupled to the anode of the nth battery cell. The output terminal of the bias voltage source VB is coupled to a non-inverting input terminal of the comparator COMP. The inverting input terminal of the comparator COMP is coupled to the low-side transmission terminal DOWN. The OR gate circuit OR1 has a first input terminal, a second input terminal and an output terminal. The first input terminal of the OR gate circuit OR1 is coupled to the one-wire interface circuit 11, to receive the status feedback signal FBS0 indicating the status of the current balance control circuit. The second input terminal of the OR gate circuit OR1 is coupled to the output terminal of the comparator COMP, to receive the status feedback signal FBS1 indicating the status of the balance control circuit located at the higher side of the daisy chain. The output terminal of the OR gate circuit OR1 is coupled to a control terminal of the switch M2, and provides the status feedback signal FBS at the status report terminal STAT to the low-side transmission terminal DOWN of the balance control circuit located at the lower side of the daisy chain.

In one hand, when the Read/Write indicating pulse burst indicating the balance control circuit in Read mode is received by the balance control circuit, the one-wire interface circuit 11 is configured to provide the status feedback signal FBS0 at the status report terminal STAT to report the status of the current balance control circuit. The status feedback signal FBS0 is transmitted to the control terminal of the switch M2 through the first input terminal of the OR gate circuit OR1, and then is transmitted to the status report terminal STAT. In the other hand, the low-side transmission terminal DOWN is coupled to the status report terminal STAT of the balance control circuit at the higher side of the daisy chain, to transmit the status feedback signal FBS1 from the higher side balance control circuit to the control terminal of the switch M2 through the second input terminal of the OR gate circuit OR1, and then to the status report terminal STAT of the current balance control circuit, and finally to the system controller 103.

FIG. 6 illustrates a balance control circuit IC in a system for balancing a battery group in accordance with an embodiment of the present disclosure. As shown in FIG. 6, a sub-group 10C comprises a first battery cell to a fifth battery cell connected by ordinal in a series structure. The balance control circuit IC comprises a one-wire interface circuit 11, a pulse transmitter 12, a pair of switches that is made up of a high-side switch QH and a low-side switch QL, a plurality of conduction paths 14A, a status transmitter 15 and a plurality of terminals.

The plurality of terminals of the balance control circuit IC include the first cell pin GND that is coupled to the cathode of the first battery cell, pins C1˜C4 coupled by ordinal to the cathode of the second battery cell to the cathode of the fifth battery cell, a pin V+ coupled to the anode of the fifth battery cell, a second power terminal P2 coupled to a switch node of the pair of the switches, and a first power terminal P1 coupled to the second power terminal P2 through an external inductor L, a digital input terminal CTRL, a high-side transmission terminal UP, a status report terminal STAT, and a low-side transmission terminal DOWN. The pair of switches and the inductor L form an energy transfer unit 13.

In the embodiment shown in FIG. 6, the first power terminal P1 is selectively coupled to the anode or the cathode of a target cell in the battery group 10C. The pair of switches is coupled between the pin V+ and the pin GND. When the first power terminal P1 is coupled to the anode of the target cell in the battery group 10C, the energy transfer unit 13 is configured to operate in the buck mode. When the first power terminal P1 is coupled to the cathode of the target cell in the battery group 10C, the energy transfer unit 13 is configured to operate in the boost mode.

In the embodiment shown in FIG. 6, the balance control circuit IC further comprises conduction paths 14A that is made up of 4 switches S1-S4. One of the conduction paths 14A is selectively activated to provide electronic connection between a second terminal of the inductor L and the anode of the target cell. In one example, each conduction path has a pair of bi-directional MOSFETs connected in series. In one embodiment, the switch S1 between the anode of the first battery cell and the second terminal of the inductor L comprises a MOSFET, the switch S4 between the cathode of 5th battery cell and the second terminal of the inductor L comprises a MOSFET.

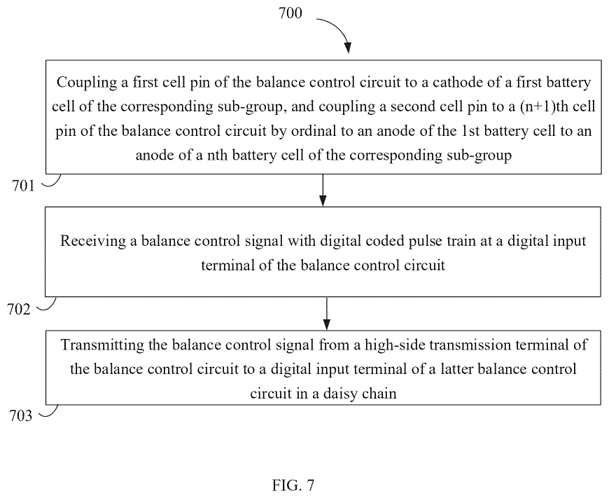

FIG. 7 illustrates a flow diagram of a method 700 for balancing a battery group in accordance with an embodiment of the present disclosure. The balance is performed by a balance control circuit. The balance control circuit and other balance control circuits are coupled in a daisy chain configuration. The battery group has k battery cells grouped into multiple sub-groups in which the nth cell (3<n<k) of a sub-group is shared by two adjacent sub-groups. The method 700 comprises steps 701˜703.

At step 701, a first cell pin of the balance control circuit is coupled to a cathode of a first battery cell of the corresponding sub-group, a second cell pin to a (n+1)th cell pin of the balance control circuit are coupled, by ordinal, to the anode of the first battery cell to the anode of the nth battery cell of the corresponding sub-group.

At step 702, a balance control signal with digital coded pulse train is received at a digital input terminal of the balance control circuit. The balance control signal are shared by the balance control circuits in the daisy chain.

In one embodiment, the digital coded pulse train has an address coded pulse burst configured to identify the address matching with the balance control circuit, a Read/Write indicating pulse burst for indicating the balance control circuit in Read mode or Write mode, and a command coded pulse burst configured to control the address-matched balance control circuit to operate for meeting the balance requirements.

At step 703, the balance control signal is transmitted from a high-side transmission terminal of the balance control circuit to another digital input terminal of a latter balance control circuit in the daisy chain.

In one embodiment, the method 700 further comprises the following steps. An inductor is coupled between a first power terminal of the balance control circuit and a second power terminal of the balance control circuit. A pair of switches coupled between the (n+1) cell pin and the first cell pin of the balance control circuit is engaged, wherein a switch node of the pair of switches is connected to the second power terminal. The first power terminal is selectively coupled to one of from the second cell pin to the nth cell pin and the switching of the pair of switches is controlled based on the balance control signal, when the address matching of the balance control circuit is identified, for meeting the balance requirements.

In one embodiment, when the Read/Write indicating pulse burst indicates that the balance control circuit is in Read mode, the balance control circuit is configured to provide a status feedback signal at a status report terminal to report the status of the balance control circuit. In a further embodiment, a low-side transmission terminal of the balance control circuit is coupled to another status report terminal of a latter balance control circuit in the daisy chain to receive the status report signal. The status feedback signal is transmitted by a status transmitter to the status report terminal of the balance control circuit and the status feedback signal is finally transmitted to a system controller.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A balance control circuit, comprising:
a first cell pin, configured to be coupled to a cathode of a first battery cell of a battery group with n battery cells connected by ordinal in a series structure;
a second cell pin to a (n+1)th cell pin, configured to be coupled by ordinal to an anode of the first battery cell to an anode of a nth battery cell of the battery group;
a first digital input terminal, configured to receive a balance control signal with digital coded pulse train, and
a first high-side transmission terminal operable to be coupled to a second digital input terminal of a latter balance control circuit in a daisy chain to transmit the balance control signal.

2. The balance control circuit of claim 1, wherein the first digital input terminal is operable to be coupled to a system controller to receive the balance control signal.

3. The balance control circuit of claim 1, wherein the first digital input terminal is operable to be coupled to a second high-side transmission terminal of a previous balance control circuit in the daisy chain, to receive the balance control signal.

4. The balance control circuit of claim 1, further comprising:
a pulse transmitter, configured to transmit the balance control signal received at the first digital input terminal to the first high-side transmission terminal.

5. The balance control circuit of claim 1, further comprising:
a first power terminal configured to be coupled to a second power terminal of the balance control circuit through an inductor;
n−1 conduction paths, wherein one of the n−1 conduction paths is selectively activated to provide electronic connection between one of from the second cell pin to the nth cell pin and the first power terminal; and
a pair of switches coupled between the (n+1) cell pin and the first cell pin, wherein a switch node of the pair of switches is connected to the second power terminal.

6. The balance control circuit of claim 5, wherein the digital coded pulse train comprising:
an address coded pulse burst configured to identify the address matching with the balance control circuit;
a Read/Write indicating pulse burst for indicating the balance control circuit in Read mode or Write mode; and
a command coded pulse burst configured to control the address-matched balance control circuit to operate for meeting balance requirements.

7. The balance control circuit of claim 6, wherein when the address matching is identified by the balance control circuit, the pair of switches is controlled and one of the n−1 conduction paths is selectively activated based on the command coded pulse burst.

8. The balance control circuit of claim 6, further comprising:
a first status report terminal, wherein when the Read/Write indicating pulse burst indicates that the balance control circuit is in Read mode, the balance control circuit is configured to provide a status feedback signal at the first status report terminal to report the status of the balance control circuit.

9. The balance control circuit of claim 8, further comprising:
a low-side transmission terminal, operable to be coupled to a second status report terminal of the latter balance control circuit in the daisy chain, to receive the status feedback signal.

10. A system for balancing a battery group with a plurality of battery cells, the plurality of battery cells are grouped into m sub-groups in which a nth battery cell (n≥3) is shared by two adjacent sub-groups, the system comprising:
m balance control circuits configured in a daisy chain and respectively configured for balancing a corresponding sub-group of the m sub-groups, wherein each balance control circuit comprising:
a first cell pin, configured to be coupled to a cathode of a first battery cell of the corresponding sub-group;
a second cell pin to a (n+1)th cell pin, coupled by ordinal to an anode of the first battery cell to an anode of the nth battery cell of the corresponding sub-group;
a digital input terminal, configured to receive a balance control signal with digital coded pulse train, and
a high-side transmission terminal operable to be coupled to a digital input terminal of a latter balance control circuit in a daisy chain to transmit the balance control signal.

11. The system of claim 10, wherein the digital input terminals of the m balance control circuits are configured to share the balance control signal.

12. The system of claim 10, wherein a system controller is configured to provide the balance control signal to the digital input terminal of the balance control circuit located at the bottom of the daisy chain.

13. The system of claim 10, wherein one balance control circuit further comprising:
a first power terminal configured to be coupled to a second power terminal of the balance control circuit through an inductor;
n−1 conduction paths, wherein one of the n−1 conduction paths is selectively activated to provide electronic connection between one of from the second cell pin to the nth cell pin and the first power terminal; and
a pair of switches coupled between the (n+1) cell pin and the first cell pin, wherein a switch node of the pair of switches is connected to the second power terminal.

14. The system of claim 13, wherein the digital coded pulse train comprising:
an address coded pulse burst configured to identify the address matching with the one balance control circuit in the daisy chain;
a Read/Write indicating pulse burst for indicating each balance control circuit in Read mode or Write mode; and
a command coded pulse burst configured to control the address-matched balance control circuit to operate for meeting balance requirements.

15. The system of claim 14, wherein when the address matching is identified, the pair of switches is controlled and one of the n−1 conduction paths is selectively activated based on the command coded pulse burst.

16. The system of claim 14, wherein the balance control circuit further comprising:
a status report terminal, wherein when the Read/Write indicating pulse burst indicates that the balance control circuit is in Read mode, the balance control circuit is configured to provide a status feedback signal at the status report terminal to report the status of the balance control circuit.

17. The system of claim 16, wherein the balance control circuit further comprises:
a low-side transmission terminal operable to be coupled to a status report terminal of a latter balance control circuit in the daisy chain, to receive the status feedback signal; and
a status transmitter configured to transmit the status feedback signal from the low-side transmission terminal to the status report terminal of the balance control circuit.

18. A method for balancing a battery group by using a balance control circuit, the battery group has a plurality of battery cells grouped into multiple sub-groups in which a nth battery cell (n≥3) is shared by two adjacent sub-groups, the method comprising:
coupling a first cell pin of the balance control circuit to a cathode of a first battery cell of the corresponding sub-group;
coupling a second cell pin to a (n+1)th cell pin of the balance control circuit by ordinal to an anode of the first battery cell to an anode of the nth battery cell of the corresponding sub-group;
receiving a balance control signal with digital coded pulse train at a first digital input terminal of the balance control circuit; and
transmitting the balance control signal from a first high-side transmission terminal of the balance control circuit to a second digital input terminal of a latter balance control circuit in a daisy chain.

19. The method of claim 18, wherein the digital coded pulse train comprising:
an address coded pulse burst configured to identify the address matching with the balance control circuit;
a Read/Write indicating pulse burst for indicating the balance control circuit in Read mode or Write mode; and
a command coded pulse burst configured to control the address-matched balance control circuit to operate for meeting balance requirements.

20. The method of claim 19, further comprising:
coupling an inductor between a first power terminal of the balance control circuit and a second power terminal of the balance control circuit;
engaging a pair of switches coupled between the (n+1) cell pin control circuit and the first cell pin of the balance control circuit, wherein a switch node of the pair of switches is connected to the second power terminal; and
selectively coupling the first power terminal to one of from the second cell pin to the nth cell pin and controlling the switching of the pair of switches, when the address matching of the balance control circuit is identified.

21. The method of claim 19, wherein:
when the Read/Write indicating pulse burst indicates that the balance control circuit is in Read mode, providing a status feedback signal at a status report terminal to report the status of the balance control circuit.

22. The method of claim 19, further comprising:
coupling a low-side transmission terminal of the balance control circuit to a status report terminal of the latter balance control circuit in the daisy chain to receive the status report signal; and
transmitting the status feedback signal by a status transmitter from the low-side transmission terminal to the status report terminal of the balance control circuit and subsequently transmitting the status feedback signal to a system controller.
